(19) United States
(12) Patent Application Publication
(10) Pub. No.: US 2009/0251807 A1
(43) Pub. Date: Oct. 8, 2009

(54) LENS MODULE

(75) Inventor: CHIA-HUNG LIAO, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/247,183

(22) Filed: Oct. 7, 2008

(30) Foreign Application Priority Data
Apr. 3, 2008 (CN) 200810300832.X

(51) Int. Cl. G02B 7/02

(52) U.S. Cl. 359/823

(57) ABSTRACT

A lens module includes a motor and a lens. The motor includes an outer frame, magnetic components, an inner frame, and a coil. The outer frame has sides and defines a passage surrounded by the sides. A recess is defined in each side. The recess has a ledge and sidewalls adjacent to the ledge. Cutouts are defined in each sidewall. Each magnetic component is positioned in a corresponding recess and contacts the ledge. The inner frame is positioned in the passage. The coil surrounds the inner frame. The lens is enclosed in the inner frame. An adhesive material member is positioned in each cutout.

### CROSS-REFERENCE STATEMENT

The present application is based on, and claims priority from, CN Application Serial Number 200810300832.X, filed on Apr. 3, 2008, titled “LENS MODULE”, the disclosure of which is hereby incorporated by reference herein in its entirety.

### BACKGROUND

1. Technical Field

The present disclosure relates to imaging devices and, particularly, to a lens module.

2. Description of Related Art

Currently, digital camera modules are included as a feature in a wide variety of electronic devices. A lens module is a critical component of the digital camera module. When digital camera modules are used, a focus distance of lenses may need to be adjusted via the lens modules to get clear images.

A typical lens module includes a lens and a motor. The motor includes a lens frame, a coil, an outer frame, and a plurality of magnetic components. The lens is secured on the lens frame. The lens frame is surrounded by the coil and enclosed in the outer frame. The plurality of magnetic components is fixed on the exterior of the outer frame by an adhesive material member. However, the structure of the typical lens module makes it difficult to inject the adhesive material member to fix each magnetic component to the outer frame.

Therefore, a new lens module is desired to overcome the above-described shortcoming.

### SUMMARY

An embodiment of a lens module includes a motor and a lens. The motor includes an outer frame, a plurality of magnetic components, an inner frame, and a coil. The outer frame has a plurality of sides and defines a passage surrounded by the plurality of sides. A recess is defined in each side. The recess has a ledge and a plurality of sidewalls adjacent to the ledge. A plurality of cutouts is defined in each sidewall. Each magnetic component is positioned in a corresponding recess and contacts the ledge. The inner frame is positioned in the passage. The coil surrounds the inner frame. The lens is enclosed in the inner frame. An adhesive material member is positioned in each cutout.

Other advantages and novel features will become more apparent from the following detailed description when taken in conjunction with the accompanying drawings.

### BRIEF DESCRIPTION OF THE DRAWINGS

Many aspects of the lens module can be better understood with reference to the following drawings. The components in the drawings are not necessarily drawn to scale, the emphasis instead being placed upon clearly illustrating the principles of the embodiment. Moreover, in the drawings, like reference numerals designate corresponding parts throughout the several views.

FIG. 1 is a perspective view of one embodiment of a lens module.

FIG. 2 is an exploded view of the lens module of FIG. 1.

FIG. 3 is a top plan view of the lens module of FIG. 1, in a stage of injecting an adhesive material member.

### DETAILED DESCRIPTION OF THE EMBODIMENT

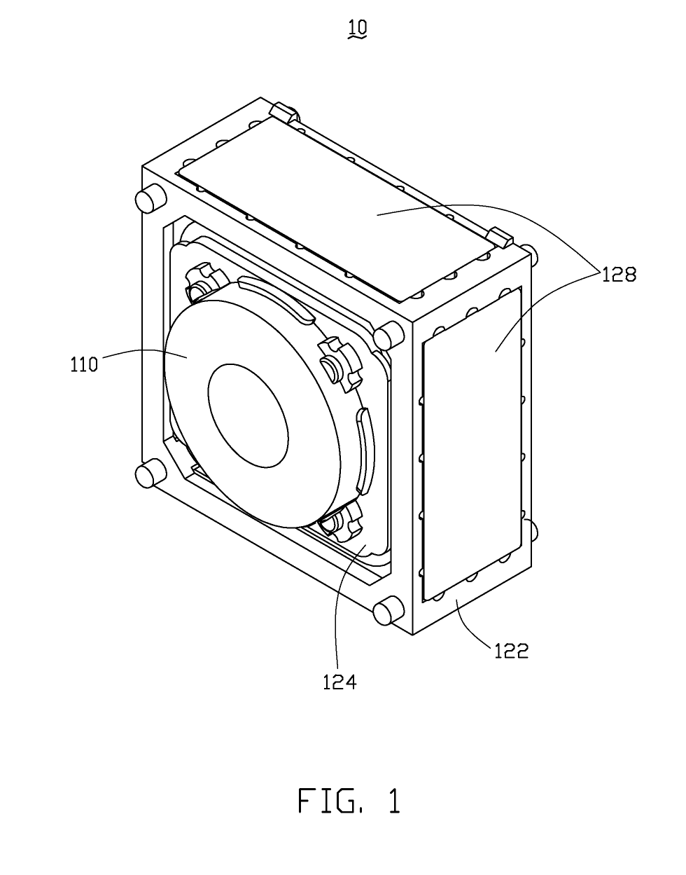

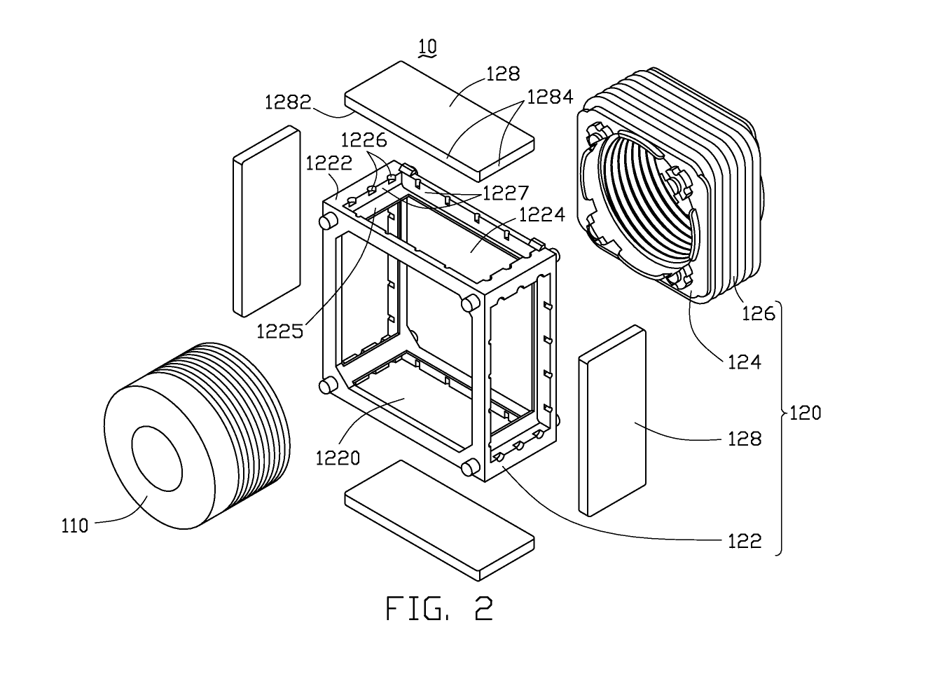

Referring to FIG. 1 and FIG. 2, one embodiment of a lens module 10 includes a lens 110 and a motor 120 enclosing the lens 110.

The motor 120 includes an outer frame 122, an inner frame 124, a coil 126, and a plurality of magnetic components 128.

The outer frame 122 has a plurality of sides 1222 and defines a passage 1220 configured to receive the inner frame 124. The plurality of sides 1222 surrounds the passage 1220. In one embodiment, the outer frame 122 may be rectangular shaped and includes four sides 1222. Each side 1222 defines a recess 1224 configured to receive a corresponding magnetic components 128. Each recess 1224 may be hollow shaped and communicates with the passage 1220. Each recess 1224 has a ledge 1225 and a plurality of first sidewalls 1227 adjacent to the ledge 1225. In one embodiment, each recess 1224 may be rectangular shaped and has four first sidewalls 1227.

A plurality of cutouts 1226 is defined in each first sidewall 1227. In one embodiment, each cutout 1226 may be semicircular shaped and has a diameter in a range from about 0.36 millimeters to about 2.75 millimeters.

The plurality of magnetic components 128 is configured to generate a magnetic field. The plurality of magnetic components may be permanent magnets. Each magnetic component 128 has a contact surface 1282 and a plurality of second sidewalls 1284 adjacent to the contact surface 1282. Each contact surface 1282 is configured to contact a corresponding ledge 1225.

The inner frame 124 defines an inner screw thread (not labeled). The lens 110 defines an outer screw thread (not labeled) configured to engage with the inner screw thread of the inner frame 124.

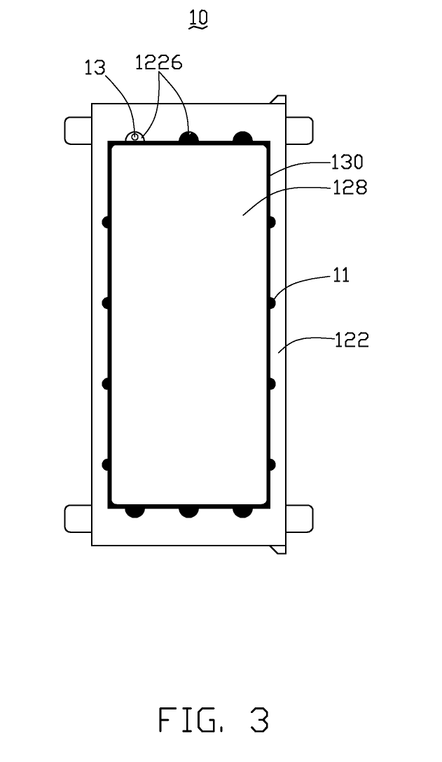

Referring also to FIG. 3, in assembly, the lens 110 is secured on the inner frame 126. The outer screw thread of the lens 110 engages with the inner screw thread of the inner frame 124. The coil 126 surrounds the inner frame 126. The inner frame 124 with the lens 110 and the coil 126 is positioned in the passage 1220. Each magnetic component 128 is positioned in a corresponding recess 1224 with the contact surfaces 1282 contacting the ledges 1225. Each second sidewall 1284 is opposite to a corresponding first sidewalls 1227. A gap 130 is defined between the first sidewalls 1227 of each recess 1224 and the second sidewalls 1284 of a corresponding magnetic component 128. The gap 130 communicates with the cutouts 1226. In one embodiment, a nozzle 13 is positioned in a cutout 1226 to inject an adhesive material member 11. The cutouts 1226 and the gap 130 are then filled with the adhesive material member 11. The magnetic component 128 is fixed to the outer frame 122 by the adhesive material member 11.

The coil 126 is driven by the magnetic field to push the inner frame 124 and the lens 110 to move along the optical axis of the lens 110 in the passage 1220 if the coil 126 is connected to a power source (not shown). As a result, the lens module 10 achieves focusing function.

Each side 1222 defines a recess 1224 and a plurality of cutouts 1226, which make it easy to inject the adhesive material member 11.

It is believed that the present embodiment and their advantages will be understood from the foregoing description, and it will be apparent that various changes may be made thereto without departing from the spirit and scope of the invention or sacrificing all of its material advantages, the examples here before described merely being preferred or exemplary embodiments of the invention.

What is claimed is:

1. A lens module comprising:
a motor comprising:
an outer frame having a plurality of sides and defining a passage surrounded by the plurality of sides, wherein a recess is defined in each of the plurality of sides and comprises a ledge and a plurality of first sidewalls adjacent to the ledge; a plurality of cutouts is defined in each of the plurality of first sidewalls;
a plurality of magnetic components configured to generate a magnetic field, each of the plurality of magnetic components being positioned in a corresponding recess and contacting the ledge;
a coil; and
an inner frame surrounded by the coil and positioned in the passage;
a lens enclosed in the inner frame; and
an adhesive material member positioned in each of the plurality of cutouts.

2. The lens module of claim 1, wherein a gap is defined between each of the plurality of magnetic components and the plurality of first sidewalls of a corresponding recess and communicates with the plurality of cutouts of the corresponding recess; the adhesive material member is positioned in the gap.

3. The lens module of claim 2, wherein the recess is hollow shaped and communicates with the passage.

4. The lens module of claim 2, wherein each of the plurality of magnetic components has a contact surface and a plurality of second sidewalls adjacent to the contact surface and opposite to the plurality of first sidewalls of the corresponding recess; the contact surface contacts the ledge.

5. The lens module of claim 1, wherein the outer frame is rectangular shaped and comprises four sides.

6. The lens module of claim 1, wherein each cutout is semicircular shaped.

7. The lens module of claim 6, wherein a diameter of each cutout is in a range from 0.36 millimeters to 2.75 millimeters.

8. The lens module of claim 1, wherein each magnetic component is a permanent magnet.

9. The lens module of claim 1, wherein each recess is rectangular shaped and has four first sidewalls.
